(19) United States
(12) Patent Application Publication
(10) Pub. No.: US 2026/0104958 A1
(43) Pub. Date: Apr. 16, 2026

(54) REGISTER SET CONTROL SYSTEM, A REGISTER SET CONTROL METHOD, A PROGRAM, AND A LOGIC CIRCUIT

(71) Applicant: Renesas Electronics Corporation, Tokyo (JP)

(72) Inventor: Yasushi TSUCHIYA, Tokyo (JP)

(21) Appl. No.: 19/297,138

(22) Filed: Aug. 12, 2025

(30) Foreign Application Priority Data
Oct. 10, 2024 (JP) 2024-177763

(51) Int. Cl. G06F 11/07

(52) U.S. Cl. CPC G06F 11/0793; G06F 11/0721; G06F 11/079

(57) ABSTRACT

A register set control system of the present disclosure judges whether each of a plurality of register sets included in a processor is normal or note, and updates state information representing that each register set is normal or not based on a result of the judgement. In addition, the register set control system selects the register sets, which are utilized for an interrupt processing by the processor, from among the register sets indicated as normality in the state information.

### CROSS-REFERENCE TO RELATED APPLICATIONS

The present application claims priority from Japanese Patent Application No. 2024-177763 filed on Oct. 10, 2024, the content of which is hereby incorporated by reference to this application.

### BACKGROUND

The present disclosure relates to a register set control system, a register set control method, a program, and a logic circuit.

There is a disclosed technique listed below.

[Patent Document 1] Japanese Unexamined Patent Application Publication No. 2023-035739

A technique for handling abnormality of a processor has been developed. For example, Patent Document 1 discloses, in a multi-Central Processing Unit (CPU) system executing a lockstep operation, a technique for handling abnormality of the CPU. In this system, when hardware abnormality occurs in one of the CPUs, the abnormal CPU is stopped and a process continues only by the normal CPU.

### SUMMARY

Patent Document 1 targets a multi-CPU system. Therefore, the technique of Patent Document 1 cannot handle the abnormality of the CPU occurring in a single-CPU system.

A register set control system according to one embodiment judges whether each of a plurality of register sets included in a processor is normal or not, and updates state information based on a result of the judgement. The state information indicates that each register set is normal or not. In addition, the register set control system selects the register sets, which are utilized for an interrupt processing by the processor, from among the normal register sets.

According to the embodiment, a new technique for handling the abnormality of the processor is provided.

### BRIEF DESCRIPTION OF THE DRAWINGS

FIG. 1 is a view exemplifying an outlie of an operation of a register set control system.

FIG. 2 is a view exemplifying selection of a register set by the register set control system.

FIG. 3 is a block diagram exemplifying a functional configuration of the register set control system.

FIG. 4 is a block diagram exemplifying a hardware configuration of a computer realizing the register set control system.

FIG. 5 is a view exemplifying a logic circuit in which a program realizing a selection unit is incorporated.

FIG. 6 is a flowchart exemplifying a flow of a process for monitoring a state of the register sets.

FIG. 7 is a flowchart exemplifying a flow of a process for selecting the register set.

FIG. 8 is a view exemplifying state information realized as a list.

FIG. 9 is a flowchart more specifically exemplifying the flow of the process for selecting the register set.

### DETAILED DESCRIPTION

Hereinafter, embodiments of the present disclosure will be detailed with reference to the drawings. In the respective drawings, the same reference numerals are denoted to the same or corresponding components and, as needed for clarifying explanation, a duplicate explanation will be omitted. In addition, unless particularly explained, predefined values such as predetermined values and thresholds are stored in advance in storage devices and the like accessible from devices utilizing the values. Further, unless particularly explained, a storage unit is configured by any number of storage devices of one or more.

### Outline

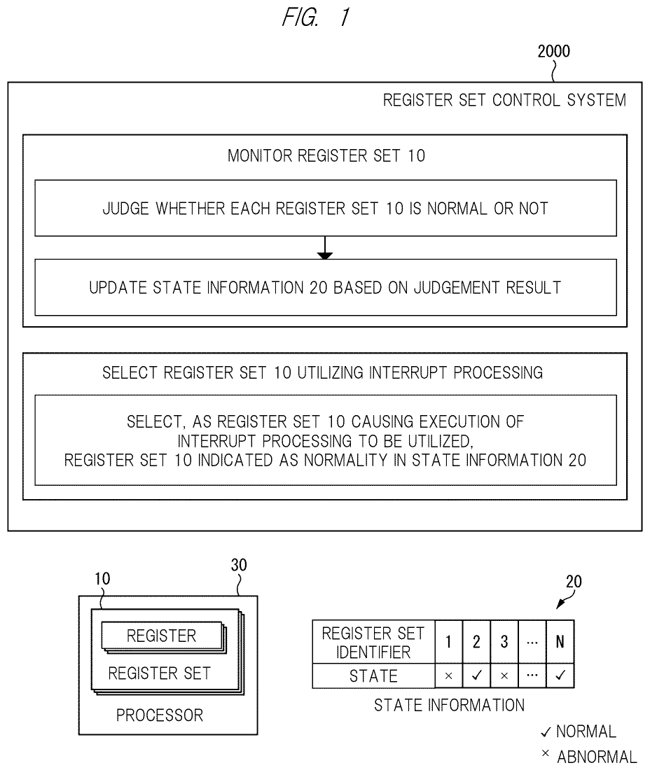

FIG. 1 is a view exemplifying an outlie of an operation of a register set control system 2000. Here, FIG. 1 is a view for easily understanding the outline of the register set control system 2000, and the operation of the register set control system 2000 is not limited to the system shown by FIG. 1.

The register set control system 2000 handles a processor 30. The processor 30 is various processors such as Microprocessor Units (MPUs), Central Processing Units (CPUs), or Field-Programmable Gate Arrays (FPGAs).

The processor 30 has a plurality of register sets 10. The register set 10 includes a plurality of registers utilized for executing a program(s). An example of the register included in the register set 10 is a program counter, a stack pointer, a data register, an address register, or the like.

In the processor 30, when an interrupt processing occurs during execution of an application, the register sets 10 different from each other are utilized by the application and the interrupt processing. In addition, also when the plurality of interrupt processings are executed, the respective different register sets 10 are utilized for the plurality of interrupt processings.

Here, in the processor, one or more register sets 10 may become abnormal. If the abnormal register 10 is utilized for a process(s), there is a possibility that the process will be unable to be normally executed.

Therefore, the register set control system 2000 monitors a state of each register set 10 so that the abnormal register set 10 is not utilized. Then, when an interrupt occurs, the register set control system 2000 selects the register set 10, which is utilized for a new interrupt processing (hereinafter, target interrupt processing), from among the normal register sets 10. The processor 30 utilizes the register set 10 selected by the register set control system 2000 and executes the target interrupt processing.

Specifically, the register set control system 2000 operates as follows. The register set control system 2000 makes a judgement of whether each of the plurality of register sets 10 is abnormal or not (abnormality judgement). Then, the register set control system 2000 updates state information 20 based on a result of the abnormality judgement. The state information 20 indicates that each register set 10 is abnormal or not. In FIG. 1, a check mark represents normality, and a cross mark represents abnormality.

When the interrupt occurs, the register set control system 2000 utilizes the state information 20, and selects the register set 10 utilized for the interrupt processing handling the above interrupt (target interrupt processing). Specifically, the register set control system 2000 selects the register set 10, which is utilized for the target interrupt processing, from among the register sets 10 indicated as normality in the state information 20. Therefore, the abnormal register set 10 is not utilized for the execution of the target interrupt processing.

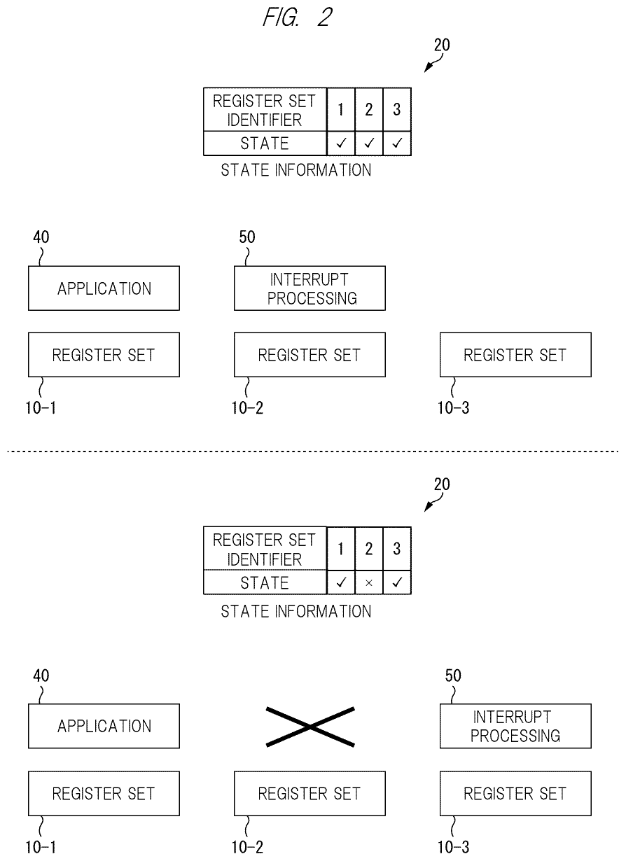

FIG. 2 is a view exemplifying selection of a register set 10 by the register set control system 2000. In FIG. 2, two cases are exemplified. Also in any case, the processor 30 has the three register sets 10 of a register set 10-1 to a register set 10-3. In addition, an application 40 is executed by utilizing the register set 10-1. Further, to handle the interrupt occurring during the execution of the application 40, an interrupt processing 50 is executed.

The interrupt processing 50 is executed by utilizing the register set 10 different from the register set 10 utilized for the execution of the application 40 (that is, the register set 10 other than the register set 10-1). In an example of FIG. 2, the register set control system 2000 preferentially selects the register set 10 having a smaller identifier.

In an upper-stage case of FIG. 2, the state information 20 indicates that all of the register sets 10 are normal. Therefore, the register set control system 2000 selects the register set 10-2 as the register set 10 utilized for the interrupt processing 50.

Meanwhile, in a lower-stage case of FIG. 2, the state information 20 indicates that the register set 10-2 is abnormal. Therefore, the register set control system 2000 selects the register set 10-3 as the register set 10 utilized for the interrupt processing 50.

### Example of Operation and Effect

According to the register set control system 2000, the abnormality judgement is made about each of the plurality of register sets 10 included in the processor 30. Then, the register set 30 judged as the abnormality is not selected as the register set 10 utilized for the interrupt processing 50. In this way, according to the register set control system 2000, the new technique for handling the abnormality of the processor is provided.

Here, the abnormality judgement of the register set 10 can be made by using the processor 30. For example, as described later, execution of a command(s), in which a value of each register included in the register set 10 is changed, in the processor 30 makes it possible to judge whether the register set 10 is normal or not. Therefore, detection of the abnormality of the register set 10 can be realized by one processor. In addition, even when a certain register set 10 becomes abnormal, causing the processor 30 to utilize the register set 10 other than the above register set 10 makes it possible to continue the utilization of the processor 30.

From the above, according to the register set control system 2000, the new technique that is realizable only by one processor and that handles the abnormality of the processor is provided. That is, according to the register set control system 2000, the new technique that is also applicable to the system of the single processor and that handles the abnormality of the processor is provided.

As the system of the single processor, for example, a small microcontroller mounted in a vehicle and the like are given. Many small microcontrollers have difficulty mounting the plurality of processors due to constraints of a space and costs. According to the register set control system 2000, even the system having difficulty mounting the plurality of processors like this can handle the abnormality of the processor.

Note that the register set control system 2000 is not necessarily applicable not only to the system of only the single-processor but also even to the system of the multi-processor.

Hereinafter, the register set control system 2000 of the present embodiment will be explained in more detail.

### Example of Functional Configuration

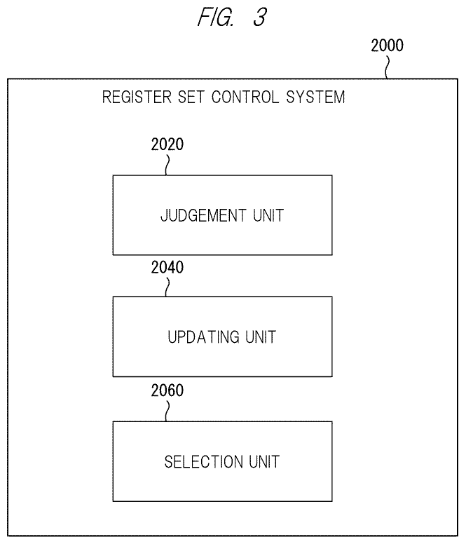

FIG. 3 is a block diagram exemplifying a functional configuration of the register set control system 2000. The register set control system 2000 has a judgement unit 2020, an updating unit 2040, and a selection unit 2060. The judgement unit 2020 makes the abnormality judgement about each of the plurality of register sets 10. The updating unit 2040 updates the state information 20 based on a result of the abnormality judgement. The selection unit 2060 selects the register set 10, which is utilized for the execution of the interrupt processing 50, from among the register sets 10 indicated as the normality in the state information 20.

### Example of Hardware Configuration

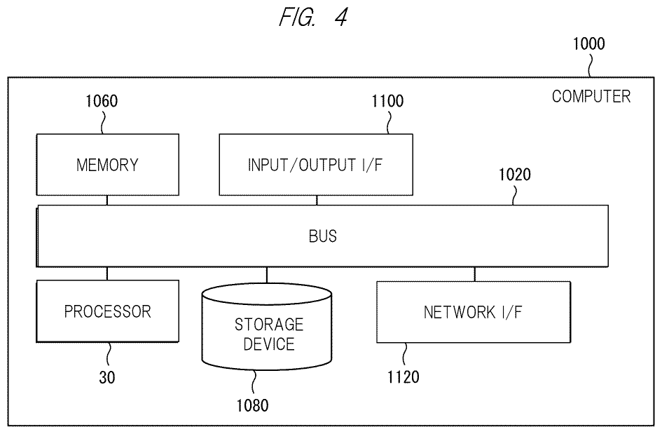

Each functional configuration unit of the register set control system 2000 may be realized by hardware (for example, hard-wired electronic circuit and the like) that realizes each functional configuration unit, or may be realized by a combination of hardware and software (for example, combination of electronic circuit and program controlling it and the like). FIG. 4 is a block diagram exemplifying a hardware configuration of a computer 1000 realizing the register set control system 2000. The computer 1000 may be any computer. The computer 1000 may be a dedicated computer designed for realizing the register set control system 2000, or may be a general-purpose computer.

The computer 1000 has the processor 30, a bus 1020, a memory 1060, a storage device 1080, an input/output interface (I/F Interface) 1100, and a network interrace 1120. The bus 1020 is a data transmission path through which the processor 30, the memory 1060, the storage device 1080, the input/output interface 1100, and the network interface 1120 transmit and receive data to and from one another. However, a method for connecting the processor 30 and the like to one another is not limited to bus connection.

The memory 1060 is a main storage realized by using a Random Access Memory (RAM) and the like. The storage device 1080 is an auxiliary storage realized by using a Read Only Memory (ROM), a flush memory, a memory card, or the like. The input/output interface 1100 is an interface for connecting the computer 1000 and an input/output device. The network interface 1120 is an interface for connecting the computer 1000 to a network.

In the storage device 1080, a program for realizing a part or all of the functional configuration units of the register set control system 2000 is stored. The processor 30 realizes each functional configuration unit of the register set control system 2000 by reading out this program to the memory 1060 and executing it.

A method of acquiring the program stored in the storage device 1080 is arbitrary. For example, by copying the program to the storage device 1080 from a storage medium in which the program is stored, the program can be acquired. The storage medium in which the program is stored is any storage medium such a Digital Versatile Disk (DVD) and a Universal Serial Bus (USB). Besides, for example, the above program is downloaded from a server device managing the storage in which the above program is stored, and can be stored in the storage device 1080.

The register set control system 2000 may have a logic circuit in which a program realizing a part or all of functions of the register set control system 2000 is incorporated in advance. For example, the programs realizing the judgement unit 2020 and the updating unit 2040 are stored in the storage device 1080, while the program realizing the selection unit 2060 is incorporated in the logic circuit. At this case, the state of the register set 10 is monitored by executing the program stored in the storage device 1080 with the processor 30. Meanwhile, the register set 10 is selected by the above logic circuit.

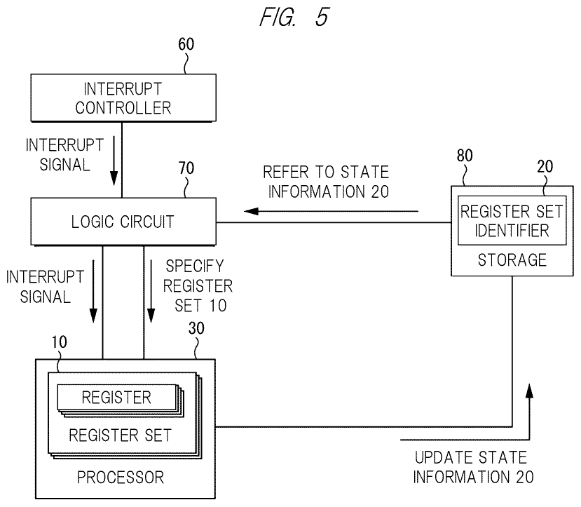

FIG. 5 is a view exemplifying a logic circuit in which a program realizing a selection unit 200 is incorporated. In FIG. 5, the logic circuit 70 is a logic circuit in which the program realizing the selection unit 2060 is incorporated. The logic circuit 70 is communicably connected to the processor 30, an interrupt controller 60, and the storage 80.

The interrupt controller 60 transmits an interrupt signal in order to convey the interrupt from the hardware to the processor 30. The interrupt signal is transmitted to the logic circuit 70.

According to receiving the interrupt signal, the logic circuit 70 selects the register set 10 utilized for the interrupt processing 50 (target interrupt processing) corresponding to the received interrupt signal. In this example, the state information 20 is stored in the storage 80. The storage 80 is any storage element realized by the RAW and the like. The logic circuit 70 refers to the state information 20 stored in the storage 80, and selects the register set 10 utilized for the target interrupt processing.

The logic circuit 70 transmits, to the processor 30, the interrupt signal and a control signal for causing the processor 30 to utilize the selected register set 1. The processor 30 executes the interrupt processing 50 corresponding to the received interrupt signal (target interrupt processing) by using the register set 10 represented by the received control signal (register set 10 selected by the register set control system 2000).

Note that in FIG. 5, the logic circuit 70 is illustrated so as to be provided outside the processor 30. However, the logic circuit 70 may be provided in the processor 30. Similarly, the storage 80 may be provided in the processor 30.

### Flow of Process

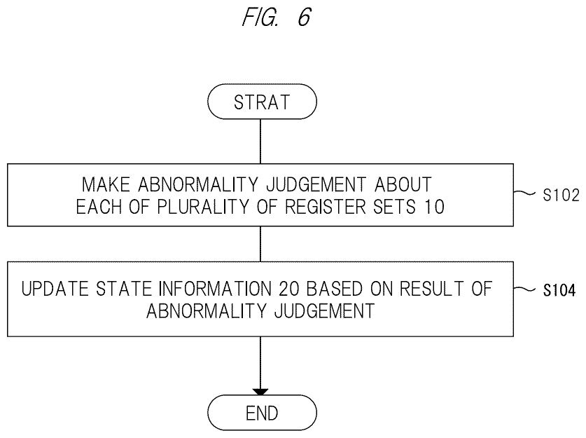

As described above, the register set control system 2000 performs the monitoring of the state of the register set 10 and the selection of the register set 10. FIG. 6 is a flowchart exemplifying a flow of a process for monitoring a state of the register set 10. The judgement unit 2020 makes the abnormality judgement about each of the plurality of register set 10 (S102). The updating unit 2040 updates the state information 20 based on the result of the abnormality judgement. Hereinafter, a series of processes (that is, updating of abnormality judgement and state information 20) shown by FIG. 6 is also called a state monitoring process.

The state monitoring process is executed repetitively. For example, the state monitoring process is repetitively executed every predetermined time. Besides, for example, the state monitoring process is executed when a predetermined time passes from the previous execution and the processor 30 is in an idle state.

Nota that the register set 10 in which the abnormality judgement is made at the one-time state monitoring process may not be all the register sets 10. For example, the number of register sets 10 in which the abnormality judgement is made at the one-time state monitoring process is M smaller than a total number N of the register sets 10. At this case, by the state monitoring process of [M/N] times, the abnormality judgement is made about all the register sets 10 every once. Here, [x] represents the smallest integer greater than or equal to x.

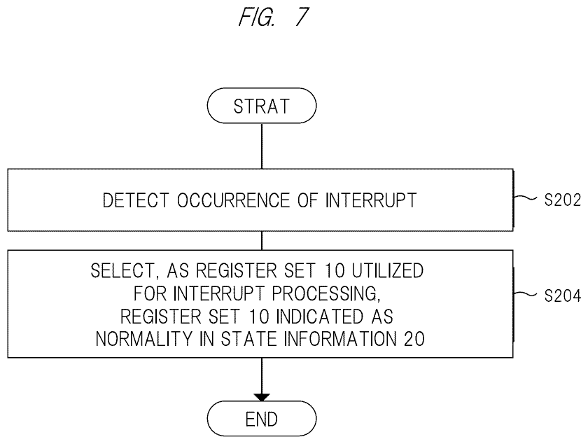

FIG. 7 is a flowchart exemplifying a flow of a process for selecting the register set 10. The selection unit 2060 detects occurrence of the interrupt (S202). The occurrence of the interrupt can be detected by receiving the interrupt signal from the interrupt controller, for example, as described above. The selection unit 2060 selects, as the register set 10 utilized for the target interrupt processing, one of the register sets 10 indicated as the normality in the state information 20 (S204)

### Abnormality Judgement: S102

The judgement unit 2020 makes the abnormality judgement about each of the plurality of register sets 10 (S102). The abnormality judgement of the register set 10 is a process for judging whether each register included in the register sets 10 is abnormal or not.

For example, when at least one register among the registers included in the register set 10 is abnormal, the judgement unit 2020 judges that the register set 10 is abnormal. Meanwhile, when all the registers included in the register set 10 are not abnormal, the judgement unit 2020 judges that the register set 10 is normal.

Here, to a technique for judging whether the register is abnormal or not, various existing techniques can be utilized. For example, whether a certain register is normal or not can be judged by using a pair of “a command in which a value of the register is changed” and “a value which should be stored in the register after the command is executed” (hereinafter, a test pair). The judgement unit 2020 utilizes one piece or more pieces of test data, and judges whether each register included in the register set 10 is abnormal or not. The test data is prepared so that the value of each register included in the register set 10 is changed at least once.

For example, it is assumed that for the abnormality judgement of a register R1, test data D1 is prepared. At this case, the test data D1 includes a command I1 in which a value of the register R1 is changed, and a value v1 which should be stored in the register R1 after executing the command I1.

The judgement unit 2020 causes the processer 30 to executes the command I1. Then, the judgment unit 2020 judges whether the value stored in the register R1 and the value v1 indicated by the test data D1 are matched or not. When those values are matched with each other, the judgement unit 2020 judges that the register R1 is normal. Meanwhile, when those values are not matched with each other, the judgement unit 2020 judges that the register R1 is abnormal.

Note that the abnormality judgement may be omitted about the register set 10 already indicated as the abnormality in the state information 20 (that is, the register set 10 judged as the abnormality in the previous abnormality judgement). At this case, the judgement unit 2020 checks the state of the i-th register set 10 indicated by the state information 20 before judging whether the i-th register set 10 is abnormal or not.

When the i-th register set 10 is indicated as the normality in the state information 20, the judgement unit 2020 makes the abnormality judgement about the i-th register set 10. Meanwhile, when the i-th register set 10 is indicated as the abnormality in the state information 20, the judgement unit 2020 makes no abnormality judgment about the i-th register set 10.

According to the above method, the number of times of making the abnormality judgement can be decreased. Therefore, a time required for the state monitoring process can be reduced. In addition, computer resources utilized for the state monitoring process can be reduced.

### Updating of State Information 20: S104

The updating unit 2040 updates the state information 20 based on the result of the abnormality judgment (S104). For example, the state information 20 indicates that all the register sets 10 are normal at an initial state. At this case, the updating unit 2040 updates the state information 20 so that the register set 10 judged as the abnormality in the abnormality judgement is indicated as the abnormality.

Here, a specific configuration of the state information 20 is arbitrary. For example, as shown in FIG. 1 and FIG. 2, the state information 20 is realized by a table associating the identifier of the register set 10 with the state of the register set 10. Besides, for example, the state information 20 is realized by a list in which the state of each register set 10 is indicated by an element(s) corresponding to the register set 10.

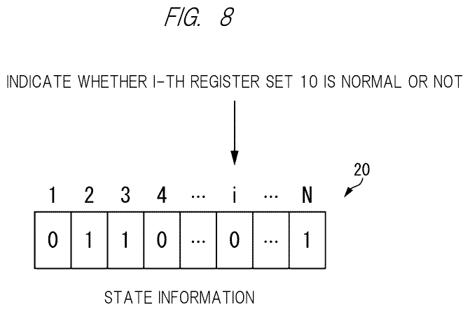

FIG. 8 is a view exemplifying state information 20 realized as a list. In FIG. 8, an i-th element of the state information 20 indicates that the i-th register set 10 is normal or not.

In an example of FIG. 8, each element of the state information indicates 0 or 1. A value 1 represents that the register set 10 is normal. Meanwhile, a value 0 represents that the register set 10 is abnormal. For example, the state information 20 indicates 1 to all the elements in the initial state. Note that a method of representing that the register set 10 is normal or not is arbitrary, and is not limited to the method explained here.

The updating unit 2040 updates the element of the state information 20 corresponding to the register set 10 judged as the abnormality in the abnormality judgement. For example, as described above, it is assumed that the abnormality of the register set 10 is represented by the value 0. At this case, the updating unit 2040 changes, to 0, the value of the element of the state information 20 corresponding to each register set 10 judged as the abnormality in the abnormality judgement.

For example, it is assumed that in the abnormality judgement, each of the 1st register set 10 and the 3rd register set 10 is judged as the abnormality. At this case, the updating unit 2040 changes, to 0, each value of the 1st element and the 3rd element of the state information 20.

### Normal End of Application 40

As a condition capable of continued use of the processor 30, a lower limit value of the number of normal register sets 10 may be set. The lower limit value of the number of normal register sets 10 is set at a value of 0 or more.

The updating unit 2040 judges whether the number of normal register sets 10 is less than the lower limit value or not after the state monitoring process. When the number of normal register sets 10 is less than the lower limit value, the updating unit 2040 ends the execution of the application 40 executed by the processor 30. By doing so, the application can be ended in the normal state. Therefore, it can be prevented that an execution result of the register set 10 leads to an abnormal result.

### Selection of Register Set 10: S204

The selection unit 2060 selects the register set 10 utilized for the execution of the target interrupt processing (S204). Here, the selection unit 2060 selects the register set 10, which is utilized for the execution of the target interrupt processing, from among the register sets 10 indicated as the normality in the state information 20.

For example, the selection unit 2060 more preferentially selects the register set 10 having the smaller identifier as exemplified by FIG. 2.

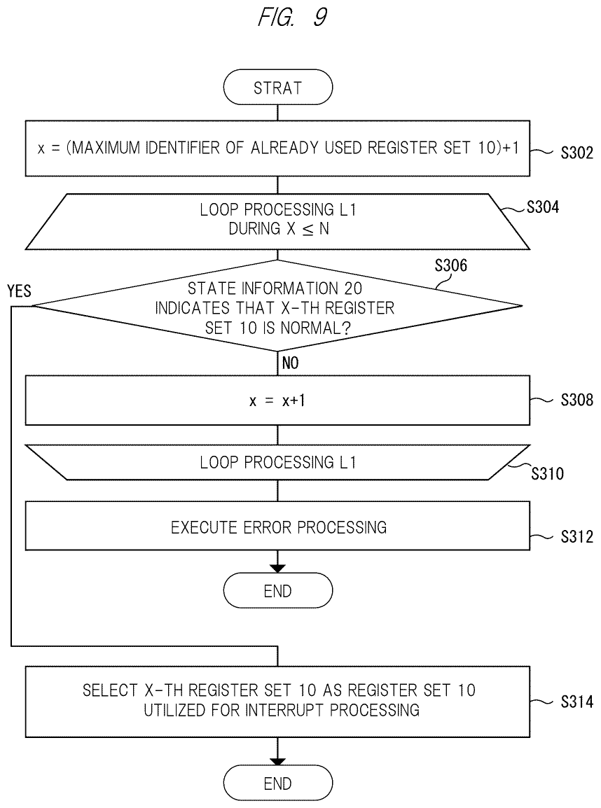

FIG. 9 is a flowchart more specifically exemplifying the flow of the process for selecting the register set 10. The selection unit 2060 sets a value, which is obtained by multiplying the maximum identifier among the identifiers of the already utilized register set 10 by 1, at a variable x representing the identifier of the register set 10 (S302).

For example, at present, it is assumed that the application 40 and one interrupt processing 50 are executed. In addition, it is also assumed that the 1st register set 10 is utilized for executing the application and that the 3rd register set 10 is utilized for executing the interrupt processing 50. At this case, in S302, 4 is set to x.

The steps S304 to S310 configure a loop processing L1. The loop processing L1 is repetitively executed while a value of x is N (total number of register sets 10) or less.

In S304, the selection unit 2060 judges whether x is N or less. When x is more than N, this means that the register set 10 capable of being utilized for the execution of the target interrupt processing is not present. Therefore, the selection unit 2060 executes an error processing (S312). For example, the error processing is a processing for ending the execution of the application 40.

In this way, when the register set 10 capable of being utilized for the execution of the target interrupt processing is not present, the application 40 can be ended in the normal state also by a method of ending the execution of the application 40. Therefore, the execution result of the application 40 can be prevented from leading to an abnormal result.

In S304, when x is N or less, the selection unit 2060 judges whether that the x-th register set 10 is normal) is indicated or not in the state information 20 (S306). When that the x-th register set 10 is normal is indicated by the state information 20 (S306), the selection unit 2060 selects the x-th register set 10 as the register set 10 utilized for the target interrupt processing (S314). Then, a process of FIG. 9 ends.

Meanwhile, it is assumed that in the state information 40, that the x-th register set 10 is normal is not indicated (S306: NO). At this case, the x-th register set 10 cannot be allocated to the target interrupt processing. Therefore, to make the next register set 10 a check target, the selection unit 2060 multiplies x by 1 (S310). Since S312 is a terminatory end of the loop processing L1, the loop processing L1 is executed again from S304.

Note that as the register set 10 has the smaller identifier, such a register set may not necessarily be selected more preferentially. For example, the selection unit 2060 may randomly select the register set 10 from among the register sets 10 indicated as the normality in the state information 20.

Besides, for example, the selection unit 2060 may select the register set 10 having the minimum number of times used so far among the register sets 10 indicated as the normality in the state information 20. By doing so, the number of used times of each register set 10 can be levelled. The selection unit 2060 stores the number of used times of each register set 10 in any storage. Specifically, the selection unit 2060 increases, by 1, the number of used times of the selected register set 10 each time selecting the register set 10.

As described above, the present disclosure has been explained with reference to the embodiments, but the present disclosure is not limited to the above embodiments. The configuration and the details of the present disclosure can be variously modified so that those skilled in the art can be understood within the scope of the present disclosure. Then, the embodiments can be combined with the other embodiments appropriately.

The respective drawings are simply exemplified for explaining one or more embodiments. The respective drawings may be associated with not only one particular embodiment but also one or more other embodiments. As will be understood by those skilled in the art, the various features or steps explained with reference to any one of the drawings can be combined with the features or steps shown by one or more other figures, for example, to create an embodiment(s) that is not shown or explained explicitly. All of the features or steps shown by any one of the figures to explain the illustrative examples are not necessarily essential, and a part of the features or steps may be omitted. Order of the steps described in any figures may be changed appropriately.

In the present disclosure, when read in the computer, the programs include command groups (or software codes) for causing the computer to execute one or more functions explained in the embodiments. The program may be stored in a non-transitory computer-readable medium or physical storage medium. As an example, not a limitation, the non-transitory computer-readable medium or physical storage medium includes: a random-access memory (RAM), a read-only memory (ROM), a flash memory, a solid-state drive (SSD), or the other memory techniques; a CD-ROM, a digital versatile disc (DVD), a Blu-ray (registered mark) disc, or the other optical disc storages; and a magnetic cassette, a magnetic tape, a magnetic disc storage, or the other magnetic storage devices. The program may be transmitted on the non-transitory computer-readable medium or communication medium. As an example, not a limitation, the non-transitory computer-readable medium or communication medium includes electric, optical, acoustic, or the other types of transmission signals.

### Note A part or all of the above embodiments can be described as noted later, but is not limited to the later notes.

### Note 1

A register set control system includes:
a judgement unit judging whether each of a plurality of register sets included in a processor is normal or not;
an updating unit updating state information representing that each of the register sets is normal or not based on a result of the judgement; and
a selection unit selecting the register sets, which are utilized for an interrupt processing by the processor, from among the register sets indicated as normality in the state information.

### Note 2

The register set control system of note 1,
in which the updating unit judges whether the number of the register sets indicated as the normality in the updated state information is a predetermined lower limit value or more, and
when the number of the register sets indicated as the normality in the updated state information is less than the predetermined lower limit value, an application executed by the processor is ended.

### Note 3

The register set control system of note 1, in which the lower limit value is 2 or more.

### Note 4

The register set control system of note 1,
in which the selection unit:
   according to receiving an interrupt signal, selects the register sets utilized for the interrupt processing corresponding to the interrupt signal; and
   transmits, to the processor, a signal having the same content as that of the received interrupt signal and a signal representing the selected register sets.

### Note 5

The register set control system of note 1,
in which programs representing a process of the judgement unit and a process of the updating unit are executed by the processor, and
a program representing a process of the selection unit is incorporated in a logic circuit different from the processor.

### Note 6

A register set control method includes:
a judgement step of judging whether each of a plurality of register sets included in a processor is normal or note;
an updating step of updating state information representing that each of the register sets is normal or not based on a result of the judgement; and
a selection step of selecting the register sets, which are utilized for an interrupt processing by the processor, from among the register sets indicated as normality in the state information.

### Note 7

A program includes causes a computer to execute:
a judgment step of judging whether each of a plurality of register sets included in a processor is normal or not; and
an updating step of updating state information representing that each of the register sets is normal or not based on a result of the judgement.

### Note 8

A logic circuit includes:
referring to state information indicating that each of a plurality of register sets included in a processor is normal or not according to detecting an interrupt; and
selecting the register sets, which the processor utilizes for an interrupt processing handling the detected interrupt, from the register sets indicated as normality in the state information.

### Note 9

A register set control system includes:
a storage element in which a command is stored; and
a processor having a plurality of register sets,
in which by executing the command, the processor includes:
   judging whether each of the plurality of register sets is normal;
   updating state information representing that each of the register sets is normal or note based on a result of the judgement; and
   selecting the register sets, which are utilized for an interrupt processing, from among the register sets indicated as normality in the state information.

### Note 10

A register set control system has:
one or more storage elements in which a command is stored;
a processor having a plurality of register sets; and
a logic circuit,
in which by executing the command, the processor includes:
   judging whether each of the plurality of register sets is normal; and
   updating state information representing that each of the register sets is normal or note based on a result of the judgement, and
the logic circuit selects the register sets, which are utilized for an interrupt processing by the processor, from among the register sets indicated as normality in the state information.

One or all of elements (for example, configurations and functions) described in note 2 to note 5 that are dependent from note 1 can be depended also from each of note 6 to note 10 by the same dependent relations as those of note 2 to note 5. One or all of the elements described in any note can be applied to various hardware, software, recoding portions for recording the software, systems, and methods.

What is claimed is:

1. A register set control system comprising:
a judgement unit judging whether each of a plurality of register sets included in a processor is normal or not;
an updating unit updating state information representing that each of the register sets is normal or not; and
a selection unit selecting the register sets, which are utilized for an interrupt processing by the processor, from among the register sets indicated as normality in the state information.

2. The register set control system according to claim 1,
wherein the updating unit:
judges whether a number of the register sets indicted as the normality in the updated state information is or not a predetermined lower limit value or more; and
when the number of the register sets indicated as the normality in the updated state information is less than the lower limit value, ends an application executed by the processor.

3. The register set control system according to claim 1,
wherein the lower limit value is 2 or more.

4. The register set control system according to claim 1,
wherein the selection unit:
according to receiving an interrupt signal, selects the register sets utilized for the interrupt processing corresponding to the interrupt signal; and
transmits, to the processor, a signal having a same content as that of the received interrupt signal and a signal representing the selected register sets.

5. The register set control system according to claim 1,
wherein a program representing a process of the judgement unit and a process of the updating unit is executed by the processor; and
wherein a program representing a process of the selection unit is incorporated in a logic circuit different from the processor.

6. A register set control method comprising:
judging whether each of a plurality of register sets included in a processor is normal or not;
updating state information representing that each of the register sets is normal or not based a result of the judgement; and
selecting the register sets, which are utilized for an interrupt processing by the processor, from among the register sets indicated as normality in the state information.

7. A program causing a computer to:
judge whether each of a plurality of register sets included in a processor is normal or not; and
update state information representing that each of the register sets is normal or not based a result of the judgement.

8. A logic circuit comprising:
refereeing to state information, which indicates that each of a plurality of register sets included in a processor is normal or not, according to detecting an interrupt; and
selecting the register sets, which the processor utilizes for an interrupt processing handling the detected interrupt, from among the register sets indicated as normality in the state information.
